(19) United States
(12) Patent Application Publication
(10) Pub. No.: US 2025/0153658 A1
(43) Pub. Date: May 15, 2025

(54) SUPPORT COMPONENT FOR INTEGRATION INTO AN APRON OF A MOTOR VEHICLE

(71) Applicant: HELLA GMBH & CO. KGAA, Lippstadt (DE)

(72) Inventors: Frank Brinkmeier, Lippstadt (DE); Heinz-Peter Kleeschulte, Anröchte (DE); Michael Lakenbrink, Oelde (DE); Konrad Schürhoff, Rietberg (DE); Thomas Thesing, Paderborn (DE); Thomas Wiese, Lippstadt (DE)

(21) Appl. No.: 18/839,812

(22) PCT Filed: Feb. 6, 2023
(86) PCT No.: PCT/EP2023/052766

§ 371 Date: Aug. 20, 2024

(30) Foreign Application Priority Data
Feb. 22, 2022 (DE) 10 2022 104 087.9

(51) Int. Cl. B60R 13/04; B60R 16/02; B62D 25/16; B62D 29/04

(52) U.S. Cl. CPC B60R 13/04; B62D 25/16; B62D 29/043; B60R 16/02

(57) ABSTRACT

The present invention relates to a support component for integration into an apron of a motor vehicle, in particular into a frontend, comprising a support body for receiving at least one electrical functional unit, in particular a sensor and/or a lighting component. According to the invention, the support body is configured as a planar component and comprises a fiber reinforced plastic based on a sheet molding compound.

### CROSS-REFERENCE TO RELATED APPLICATIONS

The present application is a national stage of International Application No. PCT/EP2023/052766, filed Feb. 6, 2023, which claims priority to German Patent Application 10-2022-104-087.9, filed Feb. 22, 2022, the disclosures of which are hereby incorporated by reference in their entirety.

### FIELD OF THE INVENTION

The present invention relates to a support component for integration into an apron of a motor vehicle, in particular into a front end, comprising a support body for receiving at least one electrical functional unit, in particular a sensor and/or a lighting component.

### BACKGROUND OF THE INVENTION

Aprons at the front, also known as the front end, or alternatively at the rear of motor vehicles form the terminal portion of the bodywork. They are usually configured as multi-part assembly units and fulfill varied functions such as air routing, shock absorption, receiving of electrical functional units and as a design element. The term “electrical functional units” is used here to refer, in particular, to sensors, for example, for the measurement of distances or for environmental monitoring, or lighting components. With regard to the receiving of electrical functional units, it is common in the state of the art to integrate a support structure into the apron, wherein this support structure is formed, in particular, by a thermoplastic injection-molded component and typically has the form of a protruding support frame. Such support structures are combined with additional decorative panels, which form an external cover and form a visible component of the apron.

### SUMMARY OF THE INVENTION

The task of the present invention is to propose an alternative embodiment of a support component for integration into an apron of a motor vehicle, which comprises a support body for receiving at least one electrical functional unit. This task is solved on the basis of a support component as described herein.

The invention includes the technical teaching whereby the support body is configured as a planar component and comprises a fiber reinforced plastic based on a sheet molding compound (SMC).

The invention is based on the idea of replacing the voluminous support structure with decorative panels known from the prior art with a compact, panel-shaped support component whose suitability in terms of mechanical and thermomechanical properties is based on the advantageous material properties of SMC. The SMC used to form the fiber reinforced plastic comprises a matrix made of a thermosetting reaction resin in which fibers with a length of preferably more than 10 millimeters are present. The support body formed from the SMC is configured as a planar component in which the fibers essentially run in one plane. The support body is characterized by high mechanical rigidity and strength, which is to say, a high resistance to shear, bending or torsional loads, particularly in the direction of the fibers, and is therefore suitable for holding electrical functional units in a load-bearing and positionally stable manner. When compared to components made of thermoplastics, the support body also has a low coefficient of thermal expansion, so that a high degree of dimensional stability is guaranteed in practical operation, even under thermal shock loads.

By way of example, the support body is configured as an injection-molded component. On the basis of the limited and isotropic shrinkage of the SMC semi-finished products used according to the invention, dimensionally stable component geometries can be realized in a cost-effective manner by injection molding. The SMC semi-finished product must therefore preferably be provided as an injection molding compound, which can be processed by means of a stuffing material supply unit on an injection molding machine.

The required material properties in terms of processability and mechanical and thermomechanical behavior are ensured in particular by SMC with a thermoset matrix based on an unsaturated polyester or vinyl ester resin with a weight proportion of the fibers of 10% to 40%. The fibers can, for example, be glass fibers, carbon fibers, synthetic fibers or organic fibers and be present in the injection molding compound as disordered individual fibers of the same or different lengths or as mat segments. By way of example, combinations of fiber types may also be present. A particularly suitable SMC comprises an unsaturated polyester resin with glass fibers of 25 millimeters in length and a diameter of 0.5-1 millimeter with a proportion by weight of the fibers of 30%.

The shape of the support body as a surface component can, for example, be dimensioned in such a way that the support component forms a panel along a significant section of the associated front or rear apron. Compared to the combination of a support structure with trim panels commonly used in the prior art, the support component according to the invention has a significantly more limited installation depth, which results in a gain of space in the area behind the relevant apron. The mechanical properties of the support component are anisotropic as a result of the orientation of the fibers within the component plane as well as a result of the geometric aspect ratios as a planar component, which is to say, that in the installation position of the support component in relation to the longitudinal axis of the motor vehicle, the high rigidity and strength is predominantly present in the transverse direction, whereas along the longitudinal axis there is greater flexibility, which is particularly desirable in the event of a collision between the motor vehicle and a pedestrian.

In an advantageous embodiment, the support component comprises at least one receiving opening for the electrical functional unit, wherein associated receiving means for fastening the electrical functional unit are molded onto and/or attached to the support body. The receiving opening is adapted in terms of its dimensions to the respective components to be received, for example, a distance sensor or a camera, and the receiving means are, for example, configured as screw bosses. These can be formed in a unitary manner on the support body, in particular in the course of production by injection molding, or attached to the support body as separate components, for example, by bonding.

In particular, the support component is provided as a visible component of the motor vehicle and has a decorative surface that is visible to a person looking at the motor vehicle. The decorative surface is the surface visible to the observer from the outside when in the intended installation position of the support component in an apron, to which corresponding demands are made in terms of design and visual appearance. The decorative surface can be formed at least in sections by a surface of the support body. The type of fiber reinforced plastic intended for the support body can have a sufficient optical surface quality and gloss, especially when manufactured by injection molding, wherein a desired color impression can be achieved by adding corresponding color pigments to the underlying SMC semi-finished product.

In a further embodiment of the support component, the decorative surface is formed at least in sections by a decorative coating and/or decorative foil applied to the support body. The decorative surface can, moreover, be formed at least in sections by a thermoplastic decorative component applied to the support body. Alternatively or in combination, the decorative surface can be formed at least in sections by a metallic decorative component applied to the support body, for example, by a metallic coating or a sheet-shaped element, which can, in particular, be back-injected through the support body.

Fasteners are preferably formed and/or attached to the support body for fastening the support component to the motor vehicle. The fasteners are configured, for example, in the form of screw bosses or screw lugs and are preferably provided for fastening to the body of the motor vehicle. The fasteners can advantageously be formed by metallic fastening components, which are, in particular, connected to the support body in a form-fit manner. In the context of manufacturing the support body by injection molding, the metallic fastening components can be overmolded as inserts in the injection molding process.

The present invention moreover relates to an assembly unit for integration into an apron of a motor vehicle, in particular into a front end, comprising a support component according to any one of the aforementioned embodiments and at least one electrical functional unit, in particular a sensor and/or a lighting component, wherein the electrical functional unit is received on the support body of the support component.

### BRIEF DESCRIPTION OF THE DRAWING

An embodiment of the invention is elucidated in more detail below with reference to the drawings, in which:

FIG. 1a shows a frontal view of a first embodiment example of the support component according to the invention;

FIG. 1b shows a rear view of the first embodiment example;

FIG. 2 shows a frontal view of a second embodiment example;

FIG. 3 shows a frontal view of a third embodiment example; and

FIG. 4 shows a frontal view of an assembly unit according to the invention.

### DETAILED DESCRIPTION OF THE CURRENT EMBODIMENTS

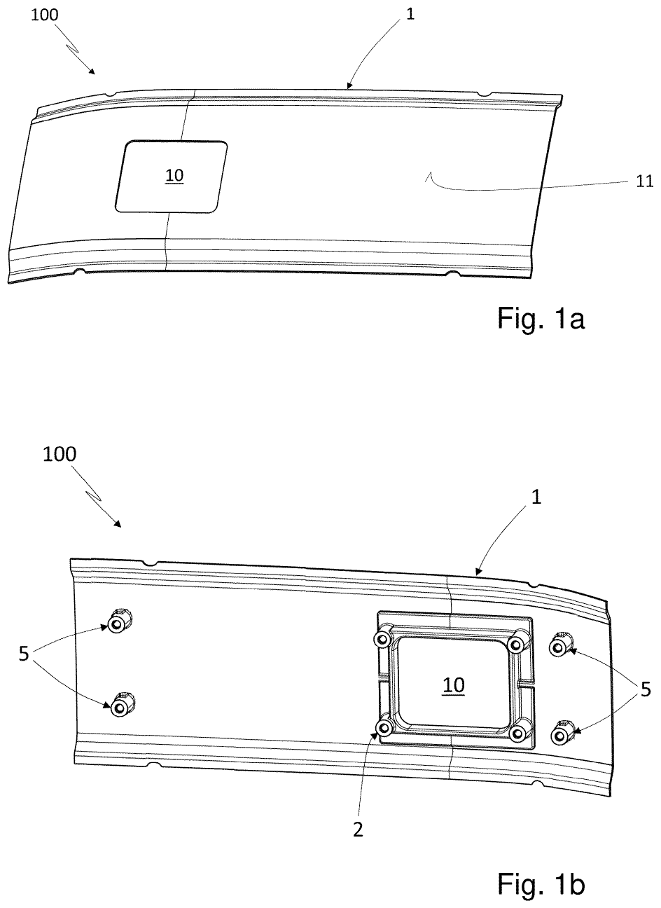

FIG. 1a and FIG. 1b show a schematic front or alternatively rear view, of a first embodiment example of the support component 100 according to the invention, which is provided for integration into an apron of a motor vehicle and comprises the support body 1 for receiving an electrical functional unit. The support body 1 is configured as a planar component and comprises a fiber reinforced plastic based on an SMC. Notwithstanding the limited installation depth of the sheet-shaped support body 1, on the basis of the fiber reinforced plastic used, it has mechanical properties which enable the support body 1 to receive an electrical functional unit in a resilient and stable position.

The support component 100 comprises, in an exemplary manner, the receiving opening 10, which is surrounded on the rear by the receiving means 2 attached to the support body 1. The receiving opening 10 together with the receiving means 2 is provided, for example, to hold and attach a camera. The receiving means 2 comprises four screw bosses connected to each other like a frame to create screw connections with the camera to be received. The receiving means 2 is glued onto the support body 1, for example.

The support component 100 moreover comprises the fasteners 5 protruding from the rear in the form of screw bosses as metal fastening components connected to the support body 1 in a form-fit manner. The fasteners 5 can, for example, be anchor-shaped, wherein the anchor heads are enclosed by the support body 1. The fasteners 5 form attachment points for integrating the support component 100 into an apron, in particular for fastening to the body of a motor vehicle.

The front side decorative surface 11 is freely visible in an apron from the outside in the provided installation position of the support component 100. In the first embodiment example, the decorative surface 11 is formed by a surface of the support body 1.

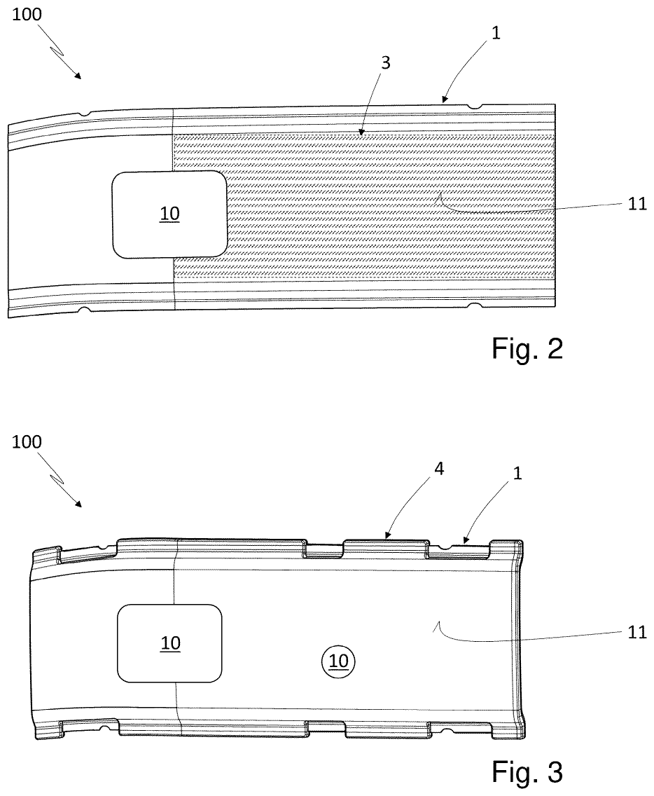

FIG. 2 shows a schematic frontal view of a second embodiment example of the support component 100 according to the invention, which differs from the first embodiment example in that the decorative surface 11 is formed in sections by the decorative foil 3, which is applied to the support body 1. Alternatively or in combination, a decorative coating could be used.

FIG. 3 shows a schematic frontal view of a third embodiment example of the support component 100 according to the invention, comprising two receiving openings 10 for electrical functional units, for example, for a camera and a distance sensor. The support body 1 is overmolded at the front side with the thermoplastic decorative component 4, which forms the decorative surface 11.

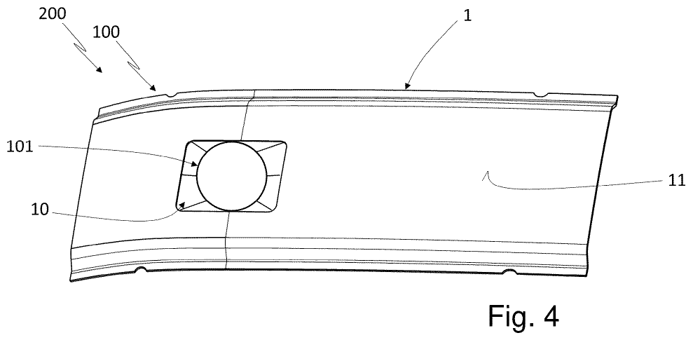

FIG. 4 shows a schematic frontal view of an assembly unit 200 according to the invention for integration into an apron of a motor vehicle, in particular into a front end, comprising the support component 100 according to the first embodiment example (see FIG. 1a and FIG. 1b) and the electrical functional unit 101 in the form of a camera for monitoring the surroundings. The receiving opening 10 exposes the required viewing angle for the electrical functional unit 101, and the electrical functional unit 101 is attached to the rear of the support body 1 via the receiving means.

The invention is not limited to the preferred embodiment example given above. Rather, a number of variants are conceivable which also make use of the solution shown, this in fundamentally different embodiments. All features and/or advantages resulting from the claims, the description or the drawings, including design details and spatial arrangements, can be significant to the invention both individually and in a wide variety of combinations.

### LIST OF REFERENCE NUMERALS

100 support component
1 support body
10 receiving opening
11 decorative surface
2 receiving means
3 decorative foil
4 thermoplastic decorative component
5 fastener
101 electrical functional unit
200 assembly unit

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A support component for integration into an apron of a motor vehicle, comprising:
a support body for receiving at an electrical functional unit, the electrical functional unit comprising sensor or a lighting component,
wherein the support body is configured as a planar component and comprises a fiber reinforced plastic that is based on a sheet molding compound.

2. The support component of claim 1, wherein the support component comprises at least one receiving opening for the electrical functional unit, wherein an associated receiving means for fastening the electrical functional unit is molded onto or attached to the support body.

3. The support component of claim 1, wherein the support component is provided as a visible component of the motor vehicle and has a decorative surface that is visible to a person looking at the motor vehicle.

4. The support component of claim 3, wherein the decorative surface is formed at least in sections by a surface of the support body.

5. The support component of claim 3, wherein the decorative surface is formed at least in sections by a decorative coating and/or a decorative foil applied to the support body.

6. The support component of claim 3, wherein the decorative surface is formed at least in sections by a thermoplastic decorative component applied to the support body.

7. The support component of claim 3, wherein the decorative surface is formed at least in sections by a metallic decorative component applied to the support body.

8. The support component of claim 1, further including fasteners that are attached to the support body for fastening the support component to the motor vehicle.

9. The support component of claim 8, wherein the fasteners include metallic fastening components connected to the support body in a form-fit manner.

10. An assembly unit for integration into an apron of a motor vehicle, the assembly unit comprising the support component of claim 1, wherein the electrical functional unit is received on the support body of the support component.
